(19) United States
(12) Patent Application Publication
(10) Pub. No.: US 2026/0135241 A1
(43) Pub. Date: May 14, 2026

(54) DUCTING SYSTEM FOR BATTERY MODULE AND BATTERY SYSTEM

(71) Applicant: Caterpillar Inc., Peoria, IL (US)

(72) Inventors: Narayanaswamy Kudithipati, Bangalore (IN); Xugang Zhang, Peoria, IL (US); Richu Gheevarghese Samuel, Alappuzha (IN); Brian Cole, Dunlap, IL (US); Jeffrey Nudd, Chillicothe, IL (US)

(73) Assignee: Caterpillar Inc., Peoria, IL (US)

(21) Appl. No.: 18/940,908

(22) Filed: Nov. 8, 2024

(51) Int. Cl. H01M 50/342; H01M 10/658; H01M 50/383

(52) U.S. Cl. CPC H01M 50/3425; H01M 10/658; H01M 50/383; H01M 2200/20

(57) ABSTRACT

A ducting system for a battery module includes one or more ducts defining a flow passage. The one or more ducts are in fluid communication with a vent portion of the battery module. A lower wall of one or more ducts defines a number of cell openings that are isolated from each other. Each cell opening provides fluid communication between the flow passage and a corresponding battery cell from a number of battery cells of the battery module. The ducting system also includes a plurality of flow regulators coupled with the one or more ducts. Each cell opening is at least partially enclosed by a corresponding flow regulator from the plurality of flow regulators. Each flow regulator from the plurality of flow regulators directs thermal runaway gases from the corresponding battery cell towards the flow passage of the one or more ducts.

### TECHNICAL FIELD

The present disclosure relates to a battery system, a ducting system for a battery module, and a method of assembling the battery module.

### BACKGROUND

A battery system can be used in a variety of applications as a means of power supply. For example, battery systems are being increasingly implemented in passenger vehicles, construction machines, and the like, to provide power supply.

The battery system includes a number of battery modules. The battery modules include high-energy density volatile battery cells to store electrical power and distribute the stored electrical power. The number of battery cells may be arranged adjacent to each other in the battery module. In some instances, one or more battery cells of the battery module may experience a thermal event, such as overheating, fire propagation, or thermal runaway. Such thermal events may result in a release of thermal runaway gases that may propagate and spread across adjacent battery cells. The thermal runaway gases may accumulate inside the battery module and may penetrate the exposed battery cells causing the battery cells to heat up quickly. This may lead to venting of the battery cells arbitrarily inside the battery module, thereby resulting in release of a large volume of thermal runaway gases that may cause damage to adjacent battery modules and other components disposed near the battery system. As such a thermal event in one battery cell may propagate to surrounding battery cells, which is not desirable.

WO2024111878 describes a battery module that comprises: a plurality of battery cells; a module case which accommodates the plurality of battery cells therein and has at least one through-hole in at least one surface thereof; and a discharge material separation and discharge unit which has one end in communication with the through-hole, is disposed outside the module case, and separates, from a discharge material discharged from the battery cells, a solid discharge material and a venting gas including a gas discharge material, wherein the discharge material separation and discharge unit collects the solid discharge material and discharges the venting gas to the outside.

### SUMMARY OF THE DISCLOSURE

In an aspect of the present disclosure, a ducting system for a battery module is provided. The ducting system includes at least one duct disposed within a housing of the battery module and defining a flow passage. The at least one duct is in fluid communication with a vent portion defined in the housing of the battery module. The at least one duct includes an upper wall. The at least one duct also includes a lower wall spaced apart from the upper wall. The flow passage of the at least one duct is at least partially defined between the upper wall and the lower wall. The lower wall defines a plurality of cell openings that are isolated from each other. Each cell opening is adapted to provide fluid communication between the flow passage of the at least one duct and a corresponding battery cell from a plurality of battery cells of the battery module. The ducting system also includes a plurality of flow regulators coupled with the at least one duct. Each cell opening is at least partially enclosed by a corresponding flow regulator from the plurality of flow regulators. Each flow regulator from the plurality of flow regulators is adapted to direct thermal runaway gases from the corresponding battery cell towards the flow passage of the at least one duct.

In another aspect of the present disclosure, a battery system is provided. The battery system includes a plurality of battery modules. Each of the plurality of battery modules includes a housing defining a vent portion. Each of the plurality of battery modules also includes a plurality of battery cells disposed within the housing. Each of the plurality of battery modules further includes a burst disc that encloses the vent portion in the housing. Each of the plurality of battery modules includes a ducting system disposed within the housing. The ducting system includes at least one duct disposed within the housing and defining a flow passage. The at least one duct is in fluid communication with the vent portion defined in the housing of the battery module. The at least one duct includes an upper wall. The at least one duct also includes a lower wall spaced apart from the upper wall. The flow passage of the at least one duct is at least partially defined between the upper wall and the lower wall. The lower wall defines a plurality of cell openings that are isolated from each other. Each cell opening is adapted to provide fluid communication between the flow passage of the at least one duct and a corresponding battery cell from the plurality of battery cells of the battery module. The ducting system also includes a plurality of flow regulators coupled with the at least one duct. Each cell opening is at least partially enclosed by a corresponding flow regulator from the plurality of flow regulators. Each flow regulator from the plurality of flow regulators is adapted to direct thermal runaway gases from the corresponding battery cell towards the flow passage of the at least one duct. The battery system also includes a gas venting assembly disposed outside the plurality of battery modules and coupled with the plurality of battery modules. The gas venting assembly includes a plurality of vent ducts. The vent portion of each of the plurality of battery modules is coupled to a corresponding vent duct from the plurality of vent ducts. The gas venting assembly also includes a common outlet duct in fluid communication with each of the plurality of vent ducts.

In yet another aspect of the present disclosure, a method of assembling a battery module is provided. The method includes disposing a plurality of battery cells within a housing of the battery module. The method also includes mounting a ducting system within the housing, such that the ducting system is disposed atop the plurality of battery cells. The ducting system includes at least one duct disposed within the housing and defining a flow passage. The at least one duct is in fluid communication with a vent portion in the housing of the battery module. The at least one duct includes an upper wall. The at least one duct also includes a lower wall spaced apart from the upper wall. The flow passage of the at least one duct is at least partially defined between the upper wall and the lower wall. The lower wall defines a plurality of cell openings that are isolated from each other. Each cell opening is adapted to provide fluid communication between the flow passage of the at least one duct and a corresponding battery cell from the plurality of battery cells of the battery module. The ducting system also includes a plurality of flow regulators coupled with the at least one duct. Each cell opening is at least partially enclosed by a corresponding flow regulator from the plurality of flow regulators. Each flow regulator from the plurality of flow regulators is adapted to direct thermal runaway gases from the corresponding battery cell towards the flow passage of the at least one duct. The method further includes defining a plurality of individual flow paths between the flow passage of the at least one duct and the corresponding battery cell from the plurality of battery cells via the corresponding flow regulator from the plurality of flow regulators, such that the individual flow paths are isolated from each other.

Other features and aspects of this disclosure will be apparent from the following description and the accompanying drawings.

### BRIEF DESCRIPTION OF THE DRAWINGS

FIG. 1 is a schematic view of a battery system, according to an example of the present disclosure;

FIG. 2 is a schematic cross-sectional view of a battery module of the battery system of FIG. 1, according to an example of the present disclosure;

FIG. 3 is a schematic perspective view of the battery module of FIG. 2 including a ducting system;

FIG. 4 is a schematic cross-sectional view of the ducting system of FIG. 3;

FIG. 5 is a schematic cross-sectional view of a portion of a ducting system that may be associated with the battery module of FIG. 2, according to another example of the present disclosure;

FIG. 6 is a schematic perspective view of the battery module including a ducting system that may be associated with the battery module of FIG. 2, according to yet another example of the present disclosure;

FIG. 7A is a schematic top perspective view of a portion of the ducting system of FIG. 6;

FIG. 7B is a schematic bottom perspective view of the portion of the ducting system of FIG. 7A;

FIG. 8 is a schematic cross-sectional view of a battery module that may be associated with the battery system of FIG. 1, according to another example of the present disclosure;

FIG. 9 is a schematic perspective view of the battery module of FIG. 8;

FIG. 10A is a schematic side view of the battery system of FIG. 1 illustrating a gas venting assembly, according to an example of the present disclosure;

FIG. 10B is an enlarged schematic view of a portion of the gas venting assembly of FIG. 10A;

FIG. 10C is a schematic front view of a gas venting assembly that may be associated with the battery module of FIG. 2, according to another example of the present disclosure;

FIG. 10D is a schematic perspective view of a gas venting assembly that may be associated with the battery module of FIG. 2, according to yet another example of the present disclosure;

FIG. 10E is a schematic front view of a gas venting assembly that may be associated with the battery module of FIG. 2, according to yet another example of the present disclosure; and

FIG. 11 is a flowchart for a method of assembling the battery module, according to an example of the present disclosure.

### DETAILED DESCRIPTION

Wherever possible, the same reference numbers will be used throughout the drawings to refer to the same or like parts.

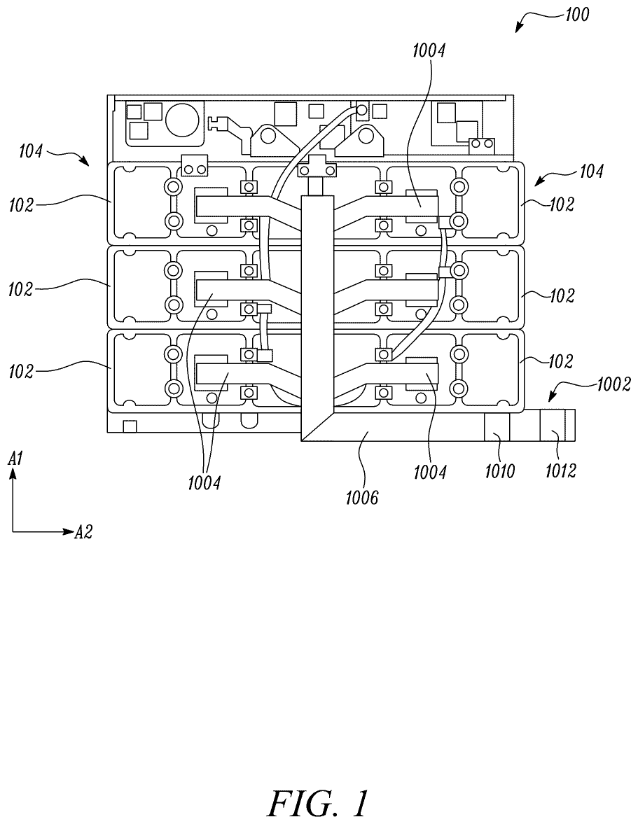

Referring to FIG. 1, a schematic view of a battery system 100 is illustrated, according to an example of the present disclosure. The battery system 100 may be used in a variety of applications as a means of power supply. For example, the battery system 100 may be used in a machine, a passenger vehicle, and the like, to provide power supply to one or more components associated therewith. The machine may include a moving machine or a stationary machine. The machine may include a work machine or a construction machine, such as, a mining truck, a wheel loader, and the like.

The battery system 100 includes a number of battery modules 102. The battery system 100 includes a pair of battery stacks 104 disposed adjacent to each other along a horizontal axis A2. Each battery stack 104 from the pair of battery stack 104 includes three battery modules that are arranged in a stacked relationship along a vertical axis A1 of the battery system 100. The number of battery modules 102 are electrically coupled together to provide a desired amount of power output and voltage output. In the illustrated example of FIG. 1, six battery modules 102 are illustrated. However, the battery system 100 may include any number of battery modules 102 that may be arranged in any configuration, based on application requirements.

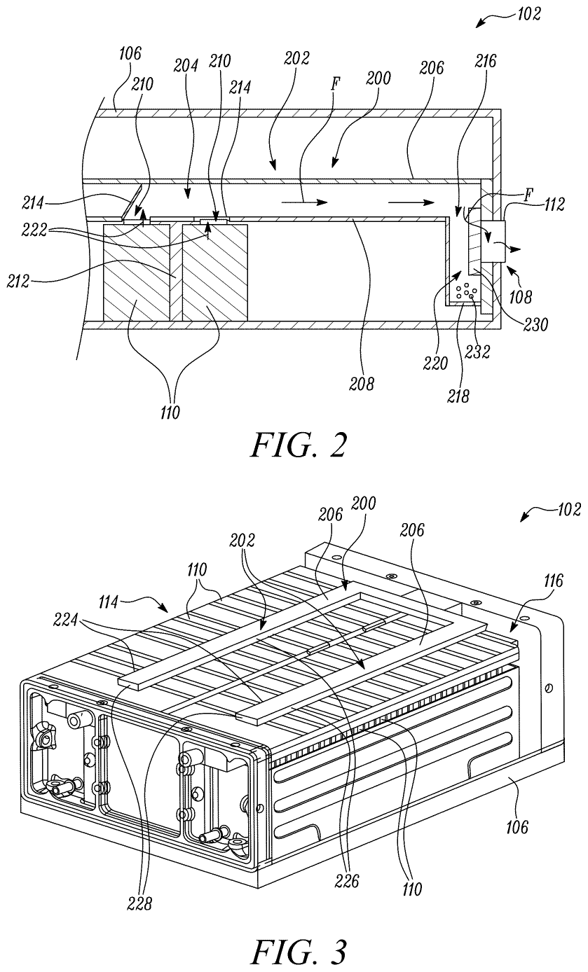

Referring to FIG. 2, a schematic cross-sectional view of a battery module 102 from the number of battery modules 102 is illustrated, according to an example of the present disclosure. It should be noted that the details of the battery module 102 provided herein are equally applicable to other battery modules 102. Each of the number of battery modules 102 includes a housing 106. In the illustrated example of FIG. 2, the housing 106 is rectangular in shape. In other examples, the housing 106 may have a square shape. In some examples, the housing 106 may be made of aluminum, composites, plastics, and/or any other suitable material.

The housing 106 defines a vent portion 108. The vent portion 108 is an outlet for thermal runaway gases that may generate during a thermal event in a battery module 102. The vent portion 108 directs the thermal runaway gases towards atmosphere. The thermal runaway gases that are released from the battery module 102 include a mixture of gases and hot solid particles 232.

Each of the number of battery modules 102 also includes a number of battery cells 110 disposed within the housing 106. The number of battery cells 110 includes a first row 114 (shown in FIG. 3) of battery cells 110 and a second row 116 (shown in FIG. 3) of battery cells 110. However, it should be noted that the number of battery cells 110 may include any number of rows of battery cells 110, based on application requirements. The battery cells 110 may include prismatic cells, for example. However, battery cells 110 may include other form factors i.e., cylindrical, pouch, blade cells, etc.

The number of battery cells 110 may incorporate, for example, a lithium-ion battery technology to store electrical power and distribute the stored electrical power at a battery module voltage and a battery module amperage. It should be noted that the power distribution and power storage characteristics of each battery module 102 may be defined at least in part on the configurations of the number of battery cells 110 included in the corresponding battery module 102. In other examples, the battery module 102 may embody any other type of battery technology/cell chemistry, such as, a lead-acid battery technology, nickel metal hydride battery technology, and the like that converts chemical energy directly to electrical energy by utilizing a difference in bond energies of the compounds utilized in the construction of the battery module 102. Further, the battery cells 110 may include any capacity, voltage, energy, etc.

Each of the number of battery modules 102 further includes a burst disc 112. The burst disc 112 encloses the vent portion 108 in the housing 106. The burst disc 112 may dislodge from the corresponding battery module 102 when a pressure within the corresponding battery module 102 exceeds a predefined pressure value. In other words, during the thermal event in the battery cell 110, a large amount of thermal runaway gases may be generated inside the corresponding battery module 102 that may increase the pressure inside the corresponding battery module 102. The pressure generated due to the thermal runaway gases may dislodge the burst disc 112 from the corresponding battery module 102. A flow of the thermal runaway gases is shown by arrows F in FIG. 2.

Each of the number of battery modules 102 includes a ducting system 200 disposed within the housing 106. The ducting system 200 is embodied as a closed loop system herein. The ducting system 200 includes a number of thermally insulative pads 212. Each thermally insulative pad 212 is disposed between a pair of adjacently disposed battery cells 110 from the number of battery cells 110. In some examples, the ducting system 200 may be made of a thermally protective material, such as, aluminum, steel, brass, a mica-based material, a fiber-reinforced material, resins, or the like. In an example, the ducting system 200 may be made from a high-temperature resistant polymer. The ducting system 200 also includes one or more ducts 202 disposed within the housing 106 of the battery module 102.

FIG. 3 is a schematic perspective view of the battery module 102 of FIG. 2. Some components of the battery module 102 are not shown in FIG. 3 for illustrative purposes. In the illustrated example of FIG. 3, the one or more ducts 202 include a first duct 202 that is in fluid communication with the first row 114 of battery cells 110 of the battery module 102 and a second duct 202 that is in fluid communication with the second row 116 of battery cells 110 of the battery module 102. The first duct 202 is hereinafter interchangeably referred to as the duct 202. The second duct 202 is hereinafter interchangeably referred to as the duct 202. However, the ducting system 200 may include any number of ducts 202, based on application requirements.

With reference to FIGS. 2 and 3, the one or more ducts 202 define a flow passage 204. The one or more ducts 202 are in fluid communication with the vent portion 108 defined in the housing 106 of the battery module 102.

The one or more ducts 202 include an upper wall 206. The one or more ducts 202 also includes a lower wall 208 spaced apart from the upper wall 206. The flow passage 204 of the one or more ducts 202 is at least partially defined between the upper wall 206 and the lower wall 208. Each of the one or more ducts 202 further includes side walls 224, 226 and a rear wall 228. Accordingly, for each duct 202, the flow passage 204 is at least partially defined between the upper wall 206, the lower wall 208, the side wall 224, the side wall 226, and the rear wall 228.

Further, the lower wall 208 defines a number of cell openings 210 that are isolated from each other. It should be noted that the number of cell openings 210 may depend on the number of battery cells 110 in the battery module 102. Each cell opening 210 provides fluid communication between the flow passage 204 of the one or more ducts 202 and a corresponding battery cell 110 from the number of battery cells 110 of the battery module 102. The lower wall 208 of the one or more ducts 202 also defines a second through-opening 216. The second through-opening 216 fluidly communicates the flow passage 204 of the one or more ducts 202 with the vent portion 108 of the housing 106.

The ducting system 200 further includes a bracket 218 disposed in front of the burst disc 112 of the battery module 102. The bracket 218 defines a closed chamber 220 that is in fluid communication with the flow passage 204 of the one or more ducts 202 via the second through-opening 216 defined in the lower wall 208 of the one or more ducts 202. The ducting system 200 also includes a spark arrestor 230 disposed before the burst disc 112.

The ducting system 200 further includes a number of flow regulators 214 coupled with the one or more ducts 202. Specifically, the flow regulators 214 are coupled to the lower wall 208. It should be noted that the number of flow regulators 214 may depend on the number of battery cells 110 of the battery module 102. In some examples, the number of flow regulators 214 may be integral with the one or more ducts 202. The number of flow regulators 214 may be glued, snap-fitted, riveted, heat stacked, or screwed, but not limited to, a busbar carrier, a cell carrier, a cell top holder, or the one or more ducts 202.

Each cell opening 210 is at least partially enclosed by a corresponding flow regulator 214 from the number of flow regulators 214. The ducting system 200 defines a number of individual flow paths 222 between the flow passage 204 of the one or more ducts 202 and the cell opening 210 of the corresponding battery cell 110 from the number of battery cells 110 via the corresponding flow regulator 214 from the number of flow regulators 214, such that the individual flow paths 222 are isolated from each other. Each flow regulator 214 from the number of flow regulators 214 directs thermal runaway gases from the corresponding battery cell 110 towards the flow passage 204 of the one or more ducts 202 via the individual flow paths 222.

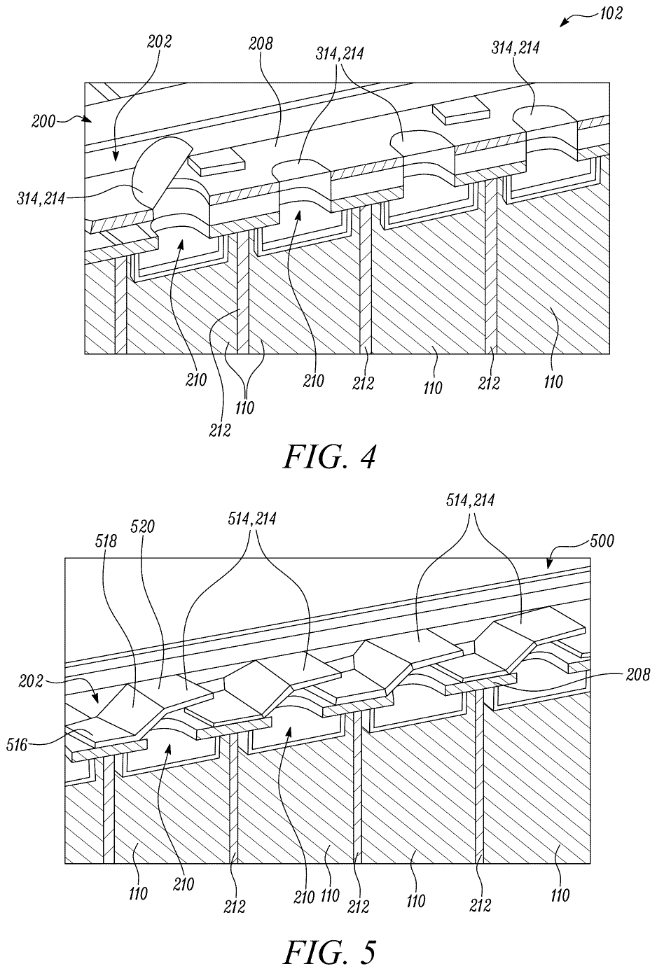

Referring to FIG. 4, a schematic cross-sectional view of the ducting system 200 of FIG. 3 is illustrated, according to an example of the present disclosure. Each flow regulator 214 from the number of flow regulators 214 includes a flap valve 314. The flap valve 314 is substantially oval. However, the flap valve 314 may have any other shape. With reference to FIGS. 2 to 4, each flap valve 314 opens, based on a release of the thermal runaway gases from the corresponding battery cell 110, to direct the thermal runaway gases from the corresponding battery cell 110 towards the flow passage 204 of the one or more ducts 202.

In an example, when a battery cell 110 experiences the thermal event, the thermal runaway gases generated during the thermal event flow towards the corresponding flap valve 314 via a corresponding cell opening 210. The flap valve 314 opens based on a contact of the thermal runaway gases with the flap valve 314, thereby causing receipt of the thermal runaway gases within the flow passage 204 of the duct 202. The thermal runaway gases are then directed towards the closed chamber 220 via the flow passage 204. The thermal runaway gases may accumulate in the closed chamber 220 such that the thermal runaway gases generate enough pressure to dislodge the burst disc 112, thereby causing the thermal runaway gases to exit the corresponding battery module 102 via the vent portion 108.

Referring to FIG. 5, a schematic cross-sectional view of a ducting system 500 that may be associated with the battery module 102 of FIG. 2 is illustrated, according to another example of the present disclosure. The ducting system 500 is substantially similar to the ducting system 200 shown in FIG. 2, with common components being referred to by the same numerals. In the illustrated example of FIG. 5, each flow regulator 214 from the number of flow regulators 214 includes a louver 514. The louver 514 defines a first portion 516 attached to the lower wall 208 of the duct 202, a second portion 518 that is angularly disposed relative to the first portion 516, and a third portion 520 that is angularly disposed relative to the second portion 518. Each cell opening 210 is in alignment with a corresponding louver 514. Further, each louver 514 deflects thermal runaway gases from the corresponding battery cell 110 towards the vent portion 108 (see FIG. 2) of the housing 106 (see FIG. 2).

In an example, when a battery cell 110 experiences the thermal event, the thermal runaway gases generated during the thermal event flow towards the corresponding louver 514 via the corresponding cell opening 210. The louver 514 deflects and directs the thermal runaway gases towards the flow passage 204 of the duct 202. The thermal runaway gases are then directed towards the closed chamber 220 (see FIG. 2) via the flow passage 204 (see FIG. 2). The thermal runaway gases may accumulate in the closed chamber 220 such that the thermal runaway gases generate enough pressure to dislodge the burst disc 112 (see FIG. 2), thereby causing the thermal runaway gases to exit the corresponding battery module 102 via the vent portion 108.

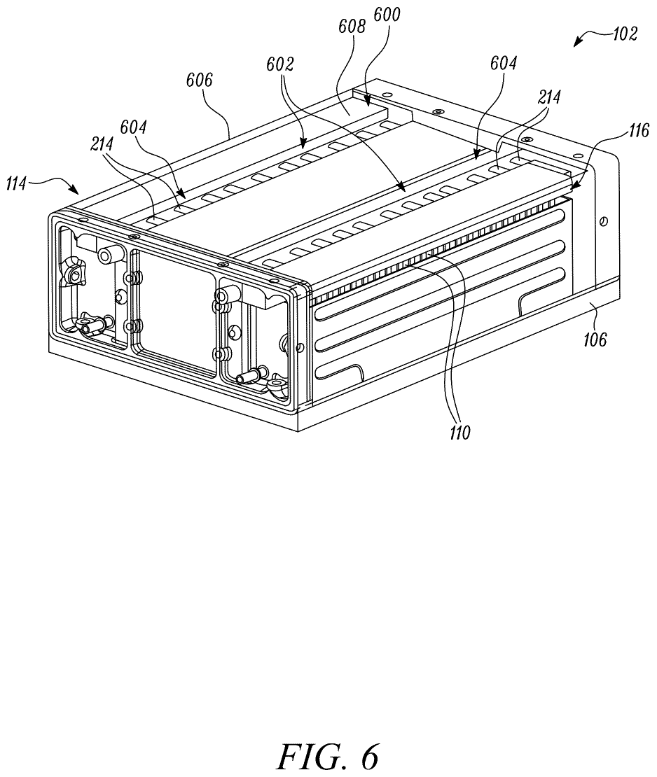

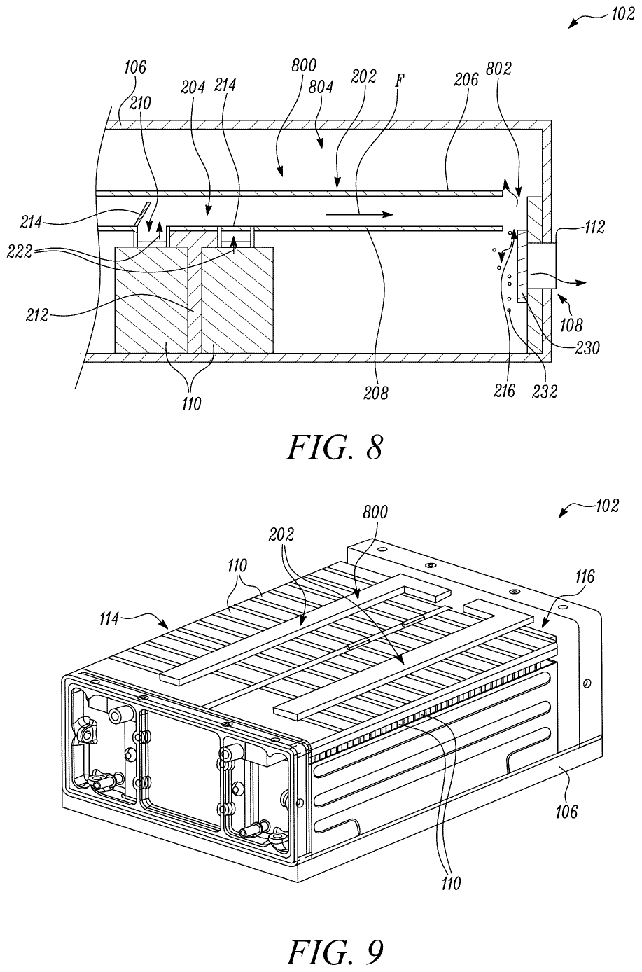

Referring to FIG. 6, a schematic perspective view of a ducting system 600 that may be associated with the battery module 102 of FIG. 2 is illustrated, according to yet another example of the present disclosure. The ducting system 600 is embodied as a closed loop system herein. Alternatively, the ducting system 600 may be embodied as an open loop system that will be described later in relation to FIGS. 8 and 9.

The ducting system 600 is substantially similar to the ducting system 200 of FIG. 2, with common components being referred to by the same numerals. However, the ducting system 600 is a single piece assembly that is disposed atop each of the first row 114 of battery cells 110 and the second row 116 of battery cells 110. The ducting system 600 includes two ducts 602 herein. Each duct 602 includes a lower wall 608. The lower wall 608 is a common wall across the two ducts 602. Further, each duct 602 includes an upper wall (not shown herein) that may be coupled with the lower wall 608 via a transition fit. The upper wall is a common wall across the two ducts 602. Each duct 602 defines a corresponding flow passage 604. The lower wall 608 defines a number of cell openings (not shown herein but are similar to the cell openings 210 of FIG. 2) that are isolated from each other. Each cell opening provides fluid communication between the flow passage 604 of the duct 602 and a corresponding battery cell 110 from the number of battery cells 110 of the battery module 102.

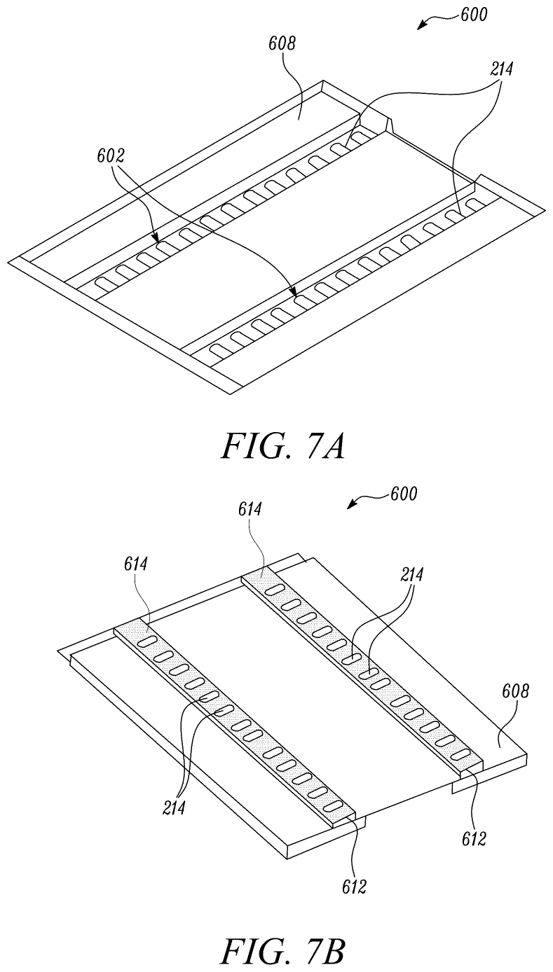

Referring to FIG. 7A, a schematic top perspective view of the ducting system 600 of FIG. 6 is illustrated, according to an example of the present disclosure. The ducting system 600 includes the number of flow regulators 214. In the illustrated example of FIG. 7A, each flow regulator 214 from the number of flow regulators 214 includes a flap valve. In another example, each flow regulator 214 from the number of flow regulators 214 may include a thin, burst type valve.

With reference to FIG. 6 to 7B, a bottom surface 612 of the lower wall 608 of the ducts 602 includes an adhesive layer 614. The adhesive layer 614 allows the ducting system 600 to be removably coupled with the number of battery cells 110. In some examples, the ducting system 600 may be removably coupled with the number of battery cells 110 via a snap fit, one or more fastening means like rivets or screws, and the like.

FIG. 8 is a schematic cross-sectional view of the battery module 102 associated with the battery system 100 of FIG. 1, according to another example of the present disclosure. FIG. 9 is a schematic perspective view of the battery module 102 of FIG. 8, with some components not shown for illustrative purpose. Referring to FIGS. 8 and 9, the battery module 102 includes a ducting system 800. The ducting system 800 is substantially similar to the ducting system 200 shown in FIG. 2, with common components being referred to by the same numerals. However, the ducting system 800 is embodied as an open loop system herein. The upper wall 206 of the one or more ducts 202 defines a first through-opening 802. The first through-opening 802 fluidly communicates the flow passage 204 of the one or more ducts 202 with a void volume 804 of the housing 106 of the battery module 102.

In an example, when a battery cell 110 experiences the thermal event, the thermal runaway gases generated during the thermal event flow towards the corresponding flow regulator 214 via the corresponding cell opening 210. The flow regulator 214 directs the thermal runaway gases towards the flow passage 204 of the duct 202. From the duct 202, some amount of the thermal runaway gases are directed towards the void volume 804 of the corresponding battery module 102 via the first through-opening 802 defined in the upper wall 206. Moreover, some amounts of the thermal runaway gases are also directed towards the burst disc 112. The thermal runaway gases present in the void volume 804 and the thermal runaway gases being directed towards the burst disc 112 together generate enough pressure to dislodge the burst disc 112, thereby causing the thermal runaway gases to exit the corresponding battery module 102 via the vent portion 108. A flow of the thermal runaway gases is shown by arrows F in FIG. 8.

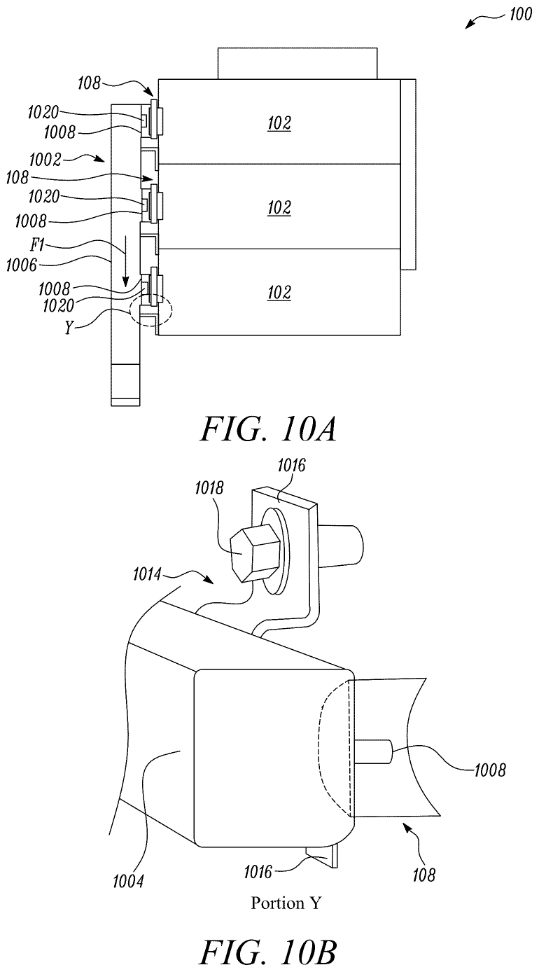

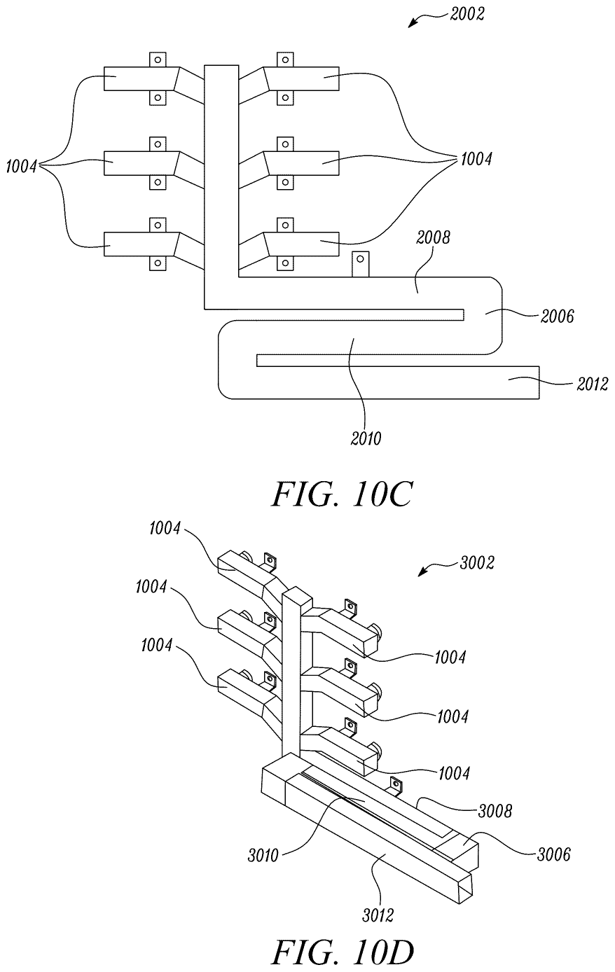

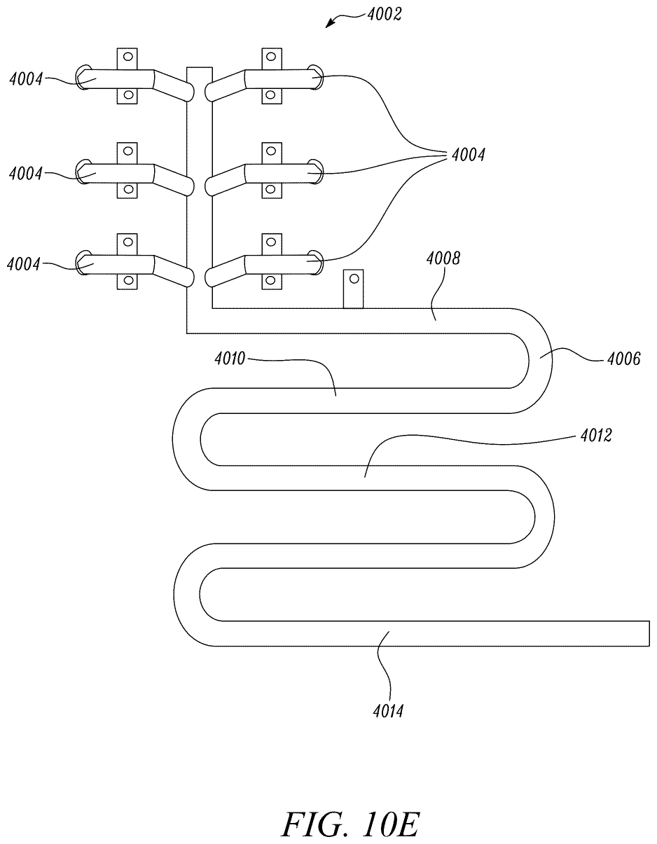

As shown in FIGS. 1 and 10A, the battery system 100 further includes a gas venting assembly 1002 disposed outside the number of battery modules 102 and coupled with the number of battery modules 102. Specifically, the gas venting assembly 1002 is coupled with each of the six battery modules 102.

Referring to FIG. 10A, a schematic side view of the battery system 100 of FIG. 1 illustrating the gas venting assembly 1002 is shown. The gas venting assembly 1002 may be made of thermally protective materials like Mica based material, a fiber reinforced material, resins, or composites. Further, the gas venting assembly 1002 may be made from different type of manufacturing methods including, but not limited to, a sheet metal fabricated type, a sheet metal stamped type, a tubular fabricated type, a single piece casting type, a flexible tubular type, and the like. The gas venting assembly 1002 can be mounted to the battery system 100 with the help of structural brackets based on design requirements. The gas venting assembly 1002 includes a number of vent ducts 1004 (shown in FIG. 1). The vent portion 108 of each of the number of battery modules 102 is coupled to a corresponding vent duct 1004 from the number of vent ducts 1004. The gas venting assembly 1002 also includes a number of gas sensors 1020 disposed between the corresponding vent duct 1004 and the vent portion 108 of the corresponding battery module 102. The gas sensor 1020 may indicate a flow of thermal runaway gases from the corresponding battery module 102.

The gas venting assembly 1002 also includes a common outlet duct 1006 in fluid communication with each of the number of vent ducts 1004. The common outlet duct 1006 has an L-shape herein. In the illustrated example of FIG. 10A, the common outlet duct 1006 and the vent ducts 1004 are illustrated having a square cross-section. However, each of the common outlet duct 1006 and the vent ducts 1004 may have a rectangular cross-section, a circular shaped cross-section, or any other cross-section, without limiting the scope of the present disclosure. Further, each of the common outlet duct 1006 and the vent ducts 1004 may have different shapes or they may have the same shape. Moreover, the common outlet duct 1006 and the vent ducts 1004 can be routed in any desired manner, as per requirements of space and design.

The gas venting assembly 1002 further includes a number of valve assemblies 1008. The vent portion 108 or the burst disc 112 of each of the number of battery modules 102 is disposed with a corresponding valve assembly 1008 from the number of valve assemblies 1008. In some examples, each valve assembly 1008 from the number of valve assemblies 1008 is a unidirectional valve.

The gas venting assembly 1002 further includes a spark arrestor 1010 (shown in FIG. 1) disposed in the common outlet duct 1006. The gas venting assembly 1002 further includes a flow valve 1012 (shown in FIG. 1) disposed downstream of the spark arrestor 1010 along a flow direction F1 of thermal runaway gases to prevent entry of hot gas particles into the common outlet duct 1006.

In an example, when a battery cell 110 (see FIG. 2) experiences the thermal event, the thermal runaway gases flow from the vent portion 108 towards the corresponding valve assembly 1008. The valve assembly 1008 then directs the thermal runaway gases towards the common outlet duct 1006 via the corresponding vent duct 1004.

Referring now to FIG. 10B, an enlarged schematic perspective view of a portion Y (shown in FIG. 10A) of the battery system 100 is illustrated. The gas venting assembly 1002 further includes a number of clamping devices 1014. The vent portion 108 of each of the number of battery modules 102 is coupled to the corresponding vent duct 1004 from the number of vent ducts 1004 by the clamping device 1014. Specifically, each clamping device 1014 from the number of clamping devices 1014 includes a pair of clamps 1016 to removably couple the corresponding vent duct 1004 with the vent portion 108 of corresponding battery module 102. Each clamp 1016 receives a corresponding fastener 1018 to removably couple the corresponding vent duct 1004 with the corresponding battery module 102. In some examples, the fasteners 1018 may include a bolt, a screw, a rivet, or the like.

Referring to FIG. 10C, a schematic front view of a gas venting assembly 2002 that may be associated with the battery module 102 of FIG. 2 is illustrated, according to another example of the present disclosure. The gas venting assembly 2002 is substantially similar to the gas venting assembly 1002 shown in FIGS. 1 and 10A, with common components being referred to by the same numerals. The gas venting assembly 2002 includes the number of vent ducts 1004. Further, in the illustrated example of FIG. 10C, the gas venting assembly 2002 includes a common outlet duct 2006 in fluid communication with each of the number of vent ducts 1004. However, a length of the common outlet duct 2006 is greater than a length of the common outlet duct 1006 shown in FIG. 1. In the illustrated example of FIG. 10B, the vent ducts 1004 and the common outlet duct 2006 have a square cross-section.

The common outlet duct 1006 includes a first section 2008, a second section 2010 in fluid communication with the first section 2008, and a third section 2012 in fluid communication with the first section 2008 and the second section 2010. The first, second, and third sections 2008, 2010, 2012 are arranged in a serpentine manner. Further, the first, second, and third sections 2008, 2010, 2012 are spaced apart from each other along a vertical plane.

Referring to FIG. 10D, a schematic perspective view of a gas venting assembly 3002 that may be associated with the battery module 102 of FIG. 2 is illustrated, according to yet another example of the present disclosure. The gas venting assembly 3002 is substantially similar to the gas venting assembly 1002 shown in FIGS. 1 and 10A, with common components being referred to by the same numerals. The gas venting assembly 3002 includes the number of vent ducts 1004. Further, in the illustrated example of FIG. 10D, the gas venting assembly 3002 includes a common outlet duct 3006 in fluid communication with each of the number of vent ducts 1004. However, a length of the common outlet duct 3006 is greater than the length of the common outlet duct 1006 shown in FIG. 1. In the illustrated example of FIG. 10D, the vent ducts 1004 and the common outlet duct 3006 have a square cross-section.

The common outlet duct 1006 includes a first section 3008, a second section 3010 in fluid communication with the first section 3008, and a third section 3012 in fluid communication with the first section 3008 and the second section 3010. The first, second, and third sections 3008, 3010, 3012 are disposed adjacent to each other along a horizontal plane.

Referring to FIG. 10E, a schematic front view of a gas venting assembly 4002 that may be associated with the battery module 102 of FIG. 2 is illustrated, according to yet another example of the present disclosure. The gas venting assembly 4002 is substantially similar to the gas venting assembly 1002 shown in FIGS. 1 and 10A, with common components being referred to by the same numerals. The gas venting assembly 4002 includes a number of vent ducts 4004. Further, the gas venting assembly 4002 includes a common outlet duct 4006 in fluid communication with each of the number of vent ducts 4004. In the illustrated example of FIG. 10E, the vent ducts 4004 and the common outlet duct 4006 have a circular cross-section. Further, a length of the common outlet duct 4006 is greater than the length of the common outlet duct 1006 shown in FIG. 1.

The common outlet duct 1006 includes a first section 4008, a second section 4010 in fluid communication with the first section 4008, a third section 4012 in fluid communication with the first section 4008 and the second section 4010, and a fourth section 4014 in fluid communication with the first, second, and third sections 4008, 4010, 4012. The first, second, third, and fourth sections 4008, 4010, 4012, 4014 are arranged in a serpentine manner. Further, the first, second, third, and fourth sections 4008, 4010, 4012, 4014 are spaced apart from each other along a vertical plane.

It is to be understood that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure is related to the ducting system 200, 500, 600, 800. The ducting system 200, 500, 600, 800 includes the ducts 202, 602. The ducting system 200, 500, 600, 800 also includes the number of flow regulators 214 coupled with the corresponding duct 202, 602. The number of flow regulators 214 may include the flap valve 314 or the louver 514 that causes the thermal runaway gases being released from corresponding battery cells 110 to be directed towards the burst disc 112. The ducting system 200, 500, 600, 800 with the C-Shaped flap valve 314, the thin burst type valve, or the louver 514 may be easier to manufacture and assemble and does not include multiple parts, which will help to route the thermal runaway gases and the hot solid particles 232 in a confined path without abrasion with any component of the battery module 102 and also prevent the thermal runaway gases from entering other battery cells 110 inside the battery module 102.

In an example, during the thermal event in the battery cell 110 from the number of battery cells 110, the ducting system 200, 600, 800 may allow the corresponding flap valve 314 to open, thereby causing the thermal runaway gases to be directed towards the burst disc 112. The integral flap valves 314 only open when the corresponding battery cell 110 experiences the thermal event and may prevent other battery cells 110 from the thermal runaway gases and hot solid particles 232. The flap valves 314 can be glued, riveted, or screwed based on space availability.

As the flow path 222 from each battery cell 110 to the flow passage 204, 604 is isolated from the adjacent battery cells 110, other battery cells 110 may be prevented from coming in contact with the thermal runaway gases. Specifically, the number of individual flow regulators 214 may prevent the thermal runaway gases from contacting any other battery cells 110 inside the battery module 102.

The flow of thermal runaway gases may be controlled by the one or more ducts 202, 602 in a confined path and may prevent particle abrasion of components of the battery module 102. The ducts 202, 602 may allow the thermal runaway gases to flow along the confined path, which may cause quick increase in the pressure within the battery module 102 to dislodge the burst disc 112. This way, the thermal runaway gases may quickly escape from the battery module 102. Further, the one or more ducts 202, 602 of the ducting system 200, 500, 600, 800 may prevent accumulation of thermal runaway gases inside the battery module 102, thereby preventing damage to the battery module 102.

The ducting system 200, 500, 600, 800 has a compact design, does not require a large amount of space for mounting, and tolerance issues may be controlled easily. The ducting system 200, 500, 600, 800 may be cost-effective, include minimal components, and may be easy to manufacture as the ducting system 200, 500, 600, 800 does not include complex components. The ducting system 200, 500, 600, 800 is simple in construction and may be easy to assemble with the battery module 102. Moreover, the ducting system 200, 500, 600, 800 prevents contact of the thermal runaway gases with busbars of the battery module 102. The ducting system 200, 500, 600, 800 provides a modular solution for any battery configuration and power/energy rating with minimal part changes.

In an example, the closed-loop type, ducting system 200 may allow the thermal runaway gases to fill faster within the closed chamber 220 and pressurize the burst disc 112 quickly and allow the thermal runaway gases to flow out of the battery module 102, which may prevent penetration of the thermal runaway gases including the hot solid particles 232 to the surrounding battery cells 110.

In an example, the open-loop type, ducting system 800 may direct the thermal runaway gases towards the burst disc 112 and may cause the thermal runaway gases to cool down below an auto ignition temperature, which may prevent heating up of other battery cells 110 inside the battery module 102.

The ducting system 200, 500, 600, 800 also includes the spark arrestor 230 attached before the burst disc 112 which may help to separate the hot solid particles 232 and allow collection of the hot solid particles 232 within the closed chamber 220. This way, the hot solid particles 232 are not released to the surrounding.

The ducting system 200, 500, 600, 800 further includes the number of thermally insulative pads 212 disposed between the pair of adjacently disposed battery cells 110. The thermally insulative pads 212 may prevent heat propagation to surrounding battery cells 110.

The battery system 100 also includes the gas venting assembly 1002. The gas venting assembly 1002 is disposed outside the number of battery modules 102 and may direct the flow of thermal runaway gases expelled during the thermal event to the atmosphere. The vent ducts 1004 and the common outlet duct 1006 of the gas venting assembly 1002 can be routed as desired so that the thermal runaway gases can exit at a desired location in such a way that the battery system 100 and surrounding systems can be protected from damage. The gas venting assembly 1002 prevents accumulation of large amounts of thermal runaway gases under a hood or a battery compartment. The gas venting assembly 1002 also includes the number of valve assemblies 1008 that may prevent the thermal runaway gases to re-enter other battery modules 102 of the battery system 100. The gas sensors 1020 of the gas venting assembly 1002 may generate a signal to indicate and notify operators or users regarding the thermal event, which may provide high egress time for operators, occupants, and nearby personnel to evacuate and may also prevent damages to the machine.

The gas venting assembly 1002 further includes the spark arrestor 1010 and the flow valve 1012 disposed downstream of the spark arrestor 1010. Each of the spark arrestor 1010 and the flow valve 1012 may prevent interaction of hot solid particles 232 in the thermal runaway gases with rich oxygen in atmospheric air and may allowing cooling of the thermal runaway gases and the hot solid particles 232 below the auto ignition temperature, which may help to prevent the thermal runaway events, may prevent damage to other battery modules 102 and/or the machine, may provide greater amount of time for operators, occupants, and/or nearby personnel to escape. The gas venting assembly 1002 is simple in design and may be cost effective to manufacture owing to the simple design thereof. The gas venting assembly 1002 may help to prevent the accumulation of large amount of thermal runaway gases at an under-hood location on a machine. Further, a length and an arrangement of the ducts 1004, 1006 can be decided to facilitate cooling of the thermal runaway gases and the hot solid particles 232 below the auto ignition temperature, while they are flowing through the gas venting assembly 1002. Particularly, in some examples, the common outlet ducts 2006, 3006, 4006 may have a greater length to facilitate cooling of the thermal runaway gases and the hot solid particles 232 below the auto ignition temperature.

Overall, the ducting system 200, 500, 600, 800 and the gas venting assembly 1002 described herein have a modular design and may be retrofitted in exiting battery systems. Moreover, the ducting system 200, 500, 600, 800 with the flow regulators 214 and the gas venting assembly 1002 may improve operational time of the battery system 100 and may improve efficiency of the battery system 100.

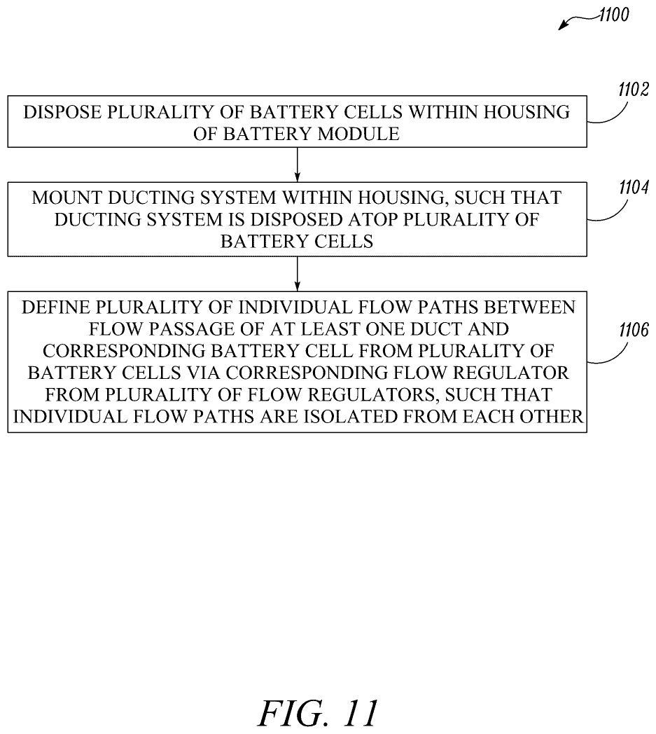

FIG. 11 is a flowchart for a method 1100 of assembling the battery module 102 of FIG. 1. With reference to FIGS. 1 to 11, at step 1102, the number of battery cells 110 are disposed within the housing 106 of the battery module 102.

At step 1104, the ducting system 200, 500, 600, 800 is mounted within the housing 106, such that the ducting system 200, 500, 600, 800 is disposed atop the number of battery cells 110. The ducting system 200, 500, 600, 800 includes the one or more ducts 202, 602 disposed within the housing 106. The one or more ducts 202, 602 define the flow passage 204, 604. The one or more ducts 202, 602 are in fluid communication with the vent portion 108 in the housing 106 of the battery module 102. The one or more ducts 202, 602 include the upper wall 206. The one or more ducts 202, 602 also include the lower wall 208, 608 spaced apart from the upper wall 206. The flow passage 204, 604 of the one or more ducts 202, 602 is at least partially defined between the upper wall 206 and the lower wall 208, 608. The lower wall 208, 608 defines the number of cell openings 210 that are isolated from each other. Each cell opening 210 provides fluid communication between the flow passage 204, 604 of the one or more ducts 202, 602 and the corresponding battery cell 110 from the number of battery cells 110 of the battery module 102. The ducting system 200, 500, 600, 800 also includes the number of flow regulators 214 coupled with the one or more ducts 202, 602. Each cell opening 210 is at least partially enclosed by the corresponding flow regulator 214 from the number of flow regulators 214. Each flow regulator 214 from the number of flow regulators 214 directs thermal runaway gases from the corresponding battery cell 110 towards the flow passage 204, 604 of the one or more ducts 202, 602.

At step 1106, the number of individual flow paths 222 are defined between the flow passage 204, 604 of the one or more ducts 202, 602 and the corresponding battery cell 110 from the number of battery cells 110 via the corresponding flow regulator 214 from the number of flow regulators 214, such that the individual flow paths 222 are isolated from each other.

The method 1100 further includes a step (not shown) at which the bracket 218 is positioned in front of the burst disc 112 of the battery module 102. The burst disc 112 encloses the vent portion 108 of the housing 106. The method 1100 further includes a step (not shown) at which the closed chamber 220 is defined within the housing 106 based on positioning of the bracket 218. The closed chamber 220 is in fluid communication with the flow passage 204, 604 of the one or more ducts 202, 602.

The method 1100 further includes a step (not shown) at which the number of thermally insulative pads 212 are disposed within the battery module 102. Each thermally insulative pad 212 is disposed between the pair of adjacently disposed battery cells 110 from the number of battery cells 110.

It should be noted that the steps 1102, 1104, 1106 of the method 1100 may be performed in a sequence that is different from that explained in relation to FIG. 11. Further, various steps 1102, 1104, 1106 can be performed together.

While aspects of the present disclosure have been particularly shown and described with reference to the embodiments above, it will be understood by those skilled in the art that various additional embodiments may be contemplated by the modification of the disclosed work machine, systems, and methods without departing from the spirit and scope of the disclosure. Such embodiments should be understood to fall within the scope of the present disclosure as determined based upon the claims and any equivalents thereof.

What is claimed is:

1. A ducting system for a battery module, the ducting system comprising:
at least one duct disposed within a housing of the battery module and defining a flow passage, wherein the at least one duct is in fluid communication with a vent portion defined in a housing of the battery module, and wherein the at least one duct includes:
an upper wall; and
a lower wall spaced apart from the upper wall, wherein the flow passage of the at least one duct is at least partially defined between the upper wall and the lower wall, wherein the lower wall defines a plurality of cell openings that are isolated from each other, and wherein each cell opening is adapted to provide fluid communication between the flow passage of the at least one duct and a corresponding battery cell from a plurality of battery cells of the battery module; and
a plurality of flow regulators coupled with the at least one duct, wherein each cell opening is at least partially enclosed by a corresponding flow regulator from the plurality of flow regulators, and wherein each flow regulator from the plurality of flow regulators is adapted to direct thermal runaway gases from the corresponding battery cell towards the flow passage of the at least one duct.

2. The ducting system of claim 1, wherein each flow regulator from the plurality of flow regulators includes a flap valve, and wherein each flap valve is adapted to open based on a release of the thermal runaway gases to direct thermal runaway gases from the corresponding battery cell towards the flow passage of the at least one duct.

3. The ducting system of claim 1, wherein each flow regulator from the plurality of flow regulators includes a louver, wherein each cell opening is in alignment with a corresponding louver, and wherein each louver deflects thermal runaway gases from the corresponding battery cell towards the vent portion of the housing.

4. The ducting system of claim 1, wherein the upper wall of the at least one duct defines a first through-opening, and wherein the first through-opening fluidly communicates the flow passage of the at least one duct with a void volume of the housing of the battery module.

5. The ducting system of claim 1, wherein the lower wall of the at least one duct defines a second through-opening, and wherein the second through-opening fluidly communicates the flow passage of the at least one duct with the vent portion of the housing.

6. The ducting system of claim 5 further comprising a bracket disposed in front of a burst disc of the battery module, wherein the burst disc encloses the vent portion in the housing, and wherein the bracket defines a closed chamber that is in fluid communication with the flow passage of the at least one duct via the second through-opening defined in the lower wall of the at least one duct.

7. The ducting system of claim 1, wherein the at least one duct includes a first duct that is in fluid communication with a first row of battery cells of the battery module and a second duct that is in fluid communication with a second row of battery cells of the battery module.

8. The ducting system of claim 1 further comprising a plurality of thermally insulative pads, wherein each thermally insulative pad is disposed between a pair of adjacently disposed battery cells from the plurality of battery cells.

9. A battery system comprising:
a plurality of battery modules, wherein each of the plurality of battery modules includes:
a housing defining a vent portion;
a plurality of battery cells disposed within the housing;
a burst disc that encloses the vent portion in the housing; and
a ducting system disposed within the housing, the ducting system including:
at least one duct disposed within the housing and defining a flow passage, wherein the at least one duct is in fluid communication with the vent portion defined in the housing of the battery module, and wherein the at least one duct includes:
an upper wall; and
a lower wall spaced apart from the upper wall, wherein the flow passage of the at least one duct is at least partially defined between the upper wall and the lower wall, wherein the lower wall defines a plurality of cell openings that are isolated from each other, and wherein each cell opening is adapted to provide fluid communication between the flow passage of the at least one duct and a corresponding battery cell from the plurality of battery cells of the battery module; and
a plurality of flow regulators coupled with the at least one duct, wherein each cell opening is at least partially enclosed by a corresponding flow regulator from the plurality of flow regulators, and wherein each flow regulator from the plurality of flow regulators is adapted to direct thermal runaway gases from the corresponding battery cell towards the flow passage of the at least one duct; and
a gas venting assembly disposed outside the plurality of battery modules and coupled with the plurality of battery modules, wherein the gas venting assembly includes:
a plurality of vent ducts, wherein the vent portion of each of the plurality of battery modules is coupled to a corresponding vent duct from the plurality of vent ducts; and
a common outlet duct in fluid communication with each of the plurality of vent ducts.

10. The battery system of claim 9, wherein each flow regulator from the plurality of flow regulators includes a flap valve, and wherein each flap valve is adapted to open based on a release of the thermal runaway gases to direct thermal runaway gases from the corresponding battery cell towards the flow passage of the at least one duct.

11. The battery system of claim 9, wherein each flow regulator from the plurality of flow regulators includes a louver, wherein each cell opening is in alignment with a corresponding louver, and wherein each louver deflects thermal runaway gases from the corresponding battery cell towards the vent portion of the housing.

12. The battery system of claim 9, wherein the upper wall of the at least one duct defines a first through-opening, and wherein the first through-opening fluidly communicates the flow passage of the at least one duct with a void volume of the housing of the battery module.

13. The battery system of claim 9, wherein the lower wall of the at least one duct defines a second through-opening, and wherein the second through-opening fluidly communicates the flow passage of the at least one duct with the vent portion of the housing.

14. The battery system of claim 13, wherein the ducting system further includes a bracket disposed in front of the burst disc of the battery module, and wherein the bracket defines a closed chamber that is in fluid communication with the flow passage of the at least one duct via the second through-opening defined in the lower wall of the at least one duct.

15. The battery system of claim 9, wherein the gas venting assembly further includes a plurality of clamping devices, and wherein the vent portion of each of the plurality of battery modules is coupled to the corresponding vent duct from the plurality of vent ducts by the clamping device.

16. The battery system of claim 9, wherein the gas venting assembly further includes a plurality of valve assemblies, and wherein the vent portion or the burst disc of each of the plurality of battery modules is disposed with a corresponding valve assembly from the plurality of valve assemblies.

17. The battery system of claim 9, wherein the gas venting assembly further includes:
a spark arrestor disposed in the common outlet duct; and
a flow valve disposed downstream of the spark arrestor along a flow direction of thermal runaway gases to prevent entry of hot gas particles into the common outlet duct.

18. A method of assembling a battery module, the method comprising:
disposing a plurality of battery cells within a housing of the battery module;
mounting a ducting system within the housing, such that the ducting system is disposed atop the plurality of battery cells, wherein the ducting system includes:
at least one duct disposed within the housing and defining a flow passage, wherein the at least one duct is in fluid communication with a vent portion in the housing of the battery module, and wherein the at least one duct includes:
an upper wall; and
a lower wall spaced apart from the upper wall, wherein the flow passage of the at least one duct is at least partially defined between the upper wall and the lower wall, wherein the lower wall defines a plurality of cell openings that are isolated from each other, and wherein each cell opening is adapted to provide fluid communication between the flow passage of the at least one duct and a corresponding battery cell from the plurality of battery cells of the battery module; and
a plurality of flow regulators coupled with the at least one duct, wherein each cell opening is at least partially enclosed by a corresponding flow regulator from the plurality of flow regulators, and wherein each flow regulator from the plurality of flow regulators is adapted to direct thermal runaway gases from the corresponding battery cell towards the flow passage of the at least one duct; and
defining a plurality of individual flow paths between the flow passage of the at least one duct and the corresponding battery cell from the plurality of battery cells via the corresponding flow regulator from the plurality of flow regulators, such that the individual flow paths are isolated from each other.

19. The method of claim 18 further comprising:
positioning a bracket in front of a burst disc of the battery module, wherein the burst disc encloses the vent portion of the housing; and
defining a closed chamber within the housing based on positioning of the bracket, wherein the closed chamber is in fluid communication with the flow passage of the at least one duct.

20. The method of claim 18 further comprising disposing a plurality of thermally insulative pads within the battery module, wherein each thermally insulative pad is disposed between a pair of adjacently disposed battery cells from the plurality of battery cells.
